(19) United States
(12) Patent Application Publication
(10) Pub. No.: US 2013/0055156 A1
(43) Pub. Date: Feb. 28, 2013

(54) INFORMATION PROCESSING TERMINAL, DISPLAY CONTROL METHOD, AND DISPLAY CONTROL PROGRAM

(71) Applicants: Yuichiro Miyamoto, Osaka (JP); Toru Utsuki, Osaka (JP)

(72) Inventors: Yuichiro Miyamoto, Osaka (JP); Toru Utsuki, Osaka (JP)

(73) Assignee: PANASONIC CORPORATION, Osaka (JP)

(21) Appl. No.: 13/510,710

(22) PCT Filed: Aug. 31, 2011
(86) PCT No.: PCT/JP2011/004883

§ 371 Date: May 18, 2012

(51) Int. Cl. G06F 3/048

(52) U.S. Cl. 715/810

(57) ABSTRACT

An information processing terminal (100) displays contents that are sorted by date information and category information. The information processing terminal (100) includes a display (114), a touch sensor (112) for detecting an input from a user on the display (114), and a control unit (140) for displaying, on the display (114), the date information including a plurality of dates, the category information including a plurality of categories, and contents belonging to a date and a category that are selected by the user from among the plurality of dates of the date information and the plurality of categories of the category information. When a date different from a date of currently displayed contents is selected, the control unit (140) displays, on the display (114), contents of the selected date that belong to the same category as a category of the currently displayed contents or a category similar to the category of the currently displayed contents.

### TECHNICAL FIELD

The present invention relates to an information processing terminal capable of displaying electronic articles and other contents that are sorted by date information and category information.

### BACKGROUND ART

In recent years, information processing terminals capable of displaying electronic articles and other similar contents on a screen have been gaining popularity. Patent Document No. 1, for example, discloses a cellular phone that can display on a display unit a body text of one of a plurality of electronic articles. This cellular phone has a button for displaying electronic articles preceding and following the currently displayed article and displays the dates of the preceding and following electronic articles in the vicinity of the button. Pressing the button displays the preceding and following articles that are in the same category as that of the currently displayed article.

Patent Document No. 2 discloses displaying a plurality of pieces of information including category information on a terminal's screen so that a user can easily find a desired article from among distributed news articles. The user can specify a desired category to have the terminal display articles in the specified category.

Patent Document No. 3 discloses a display device capable of displaying, instead of electronic articles, a program listing sorted by time, channel, and category. A user can select a desired category from a plurality of categories to have the display device display a program listing in the selected category. This allows a user to search for objective program information intuitively.

### CITATION LIST

### Patent Literature

Patent Document No. 1: Japanese Patent Application Laid-Open Publication No. 2009-15506
Patent Document No. 2: Japanese Patent Application Laid-Open Publication No. 2002-215732
Patent Document No. 3: Japanese Patent Application Laid-Open Publication No. 10-191193

### SUMMARY OF INVENTION

### Technical Problems

The devices disclosed in Patent Documents No. 1 to No. 3 are not capable of displaying a desired article by selecting a particular date and category in one screen from among a plurality of dates of date information and a plurality of categories of category information. Conventional technologies also cannot deal with the case where the user wishes to read contents of a related category after changing the date.

The present invention has been made in view of the above-mentioned problems, and an object of the present invention is to provide an information processing terminal that keeps displaying contents of a related category after the date is changed.

### Solution to Problems

An information processing terminal according to the present invention can display contents that are sorted by date information and category information. The information processing terminal includes a display, a touch sensor that detects an input from a user on the display, and a control unit that displays, on the display, the date information including a plurality of dates, the category information including a plurality of categories, and contents belonging to a date and a category that are selected by the user from among the plurality of dates of the date information and the plurality of categories of the category information. When a date different from a date of currently displayed contents is selected, the control unit displays, on the display, contents of the selected date that belong to the same category as a category of the currently displayed contents or a category similar to category of the currently displayed contents.

In an embodiment of the present invention, when the date different from the date of currently displayed contents is selected and there are no contents of the selected date that belong to the same category as the category of the currently displayed contents or the category similar to the category of the currently displayed contents, the control unit displays, on the display, an initial screen, which is set in advance, for the selected date.

In an embodiment of the present invention, the display displays, as the date information, days within a preset period of time at the same time.

In an embodiment of the present invention, the contents are newspaper articles.

In an embodiment of the present invention, when the date different from the date of currently displayed contents is selected and there are no contents of the selected date that belong to the same category as the category of the currently displayed contents or the category similar to the category of the currently displayed contents, the control unit displays, on the display, information about an article of a front page of a newspaper on the selected date.

Another information processing terminal according to the present invention displays contents that are sorted by date information and category information. The information processing terminal includes a display, a touch sensor that detects an input from a user on the display, a memory, a processor, and a program stored in the memory. The program controls the processor to execute the steps of: displaying, on the display, the date information including a plurality of dates, the category information including a plurality of categories, and contents belonging to a date and a category that are selected by the user from among the plurality of dates of the date information and the plurality of categories of the category information; and when a date different from a date of currently displayed contents is selected, displaying, on the display, contents of the selected date that belong to the same category as a category of the currently displayed contents or a category similar to the category of the currently displayed contents.

A display control method according to the present invention is for use in an information processing terminal for displaying contents that are sorted by date information and category information. The display control method includes the steps of: displaying, on a display of the information processing terminal, the date information including a plurality of dates, the category information including a plurality of categories, and contents belonging to a date and a category that are selected by a user from among the plurality of dates of the date information and the plurality of categories of the category information; and when a date different from a date of currently displayed contents is selected, displaying, on the display, contents of the selected date that belong to the same category as a category of the currently displayed contents or a category similar to the category of the currently displayed contents.

A display control program according to the present invention is for use in an information processing terminal for displaying contents that are sorted by date information and category information. The display control program controls a computer to execute the steps of: displaying, on a display of the information processing terminal, the date information including a plurality of dates, the category information including a plurality of categories, and contents belonging to a date and a category that are selected by a user from among the plurality of dates of the date information and the plurality of categories of the category information; and when a date different from a date of currently displayed contents is selected, displaying, on the display, contents of the selected date that belong to the same category as a category of the currently displayed contents or a category similar to the category of the currently displayed contents.

### Advantageous Effects of Invention

According to the present invention, when the date is changed, contents highly related to currently displayed contents are displayed and users' convenience is thus improved.

### BRIEF DESCRIPTION OF DRAWINGS

FIG. 1 is a diagram illustrating the exterior appearance of an information processing terminal according to an embodiment.

FIG. 2 is a block diagram illustrating a hardware configuration of the information processing terminal according to the embodiment.

FIG. 3 are diagrams illustrating screen configuration examples of the information processing terminal according to the embodiment.

FIG. 4 is a diagram illustrating an example of categories and groups.

FIG. 5 are diagrams illustrating an example of transition between screens.

FIG. 6 are diagrams illustrating an example of screen transition in a date changing operation.

FIG. 7 is a flow chart illustrating the processing flow of the date changing operation.

FIG. 8 are diagrams illustrating another example of screen transition concerning a newspaper page image.

FIG. 9 are diagrams illustrating an example of screen transition concerning a switch between horizontal writing display and vertical writing display.

FIG. 10 are diagrams illustrating an example of display for alerting the fact that the screen cannot be scrolled further.

FIG. 11 is a diagram illustrating an example of information communication between the information processing terminal and a distribution server.

FIG. 12 is a diagram illustrating an example of the data structure of distributed contents.

### DESCRIPTION OF EMBODIMENTS

An embodiment of the present invention is described below with reference to the accompanying drawings.

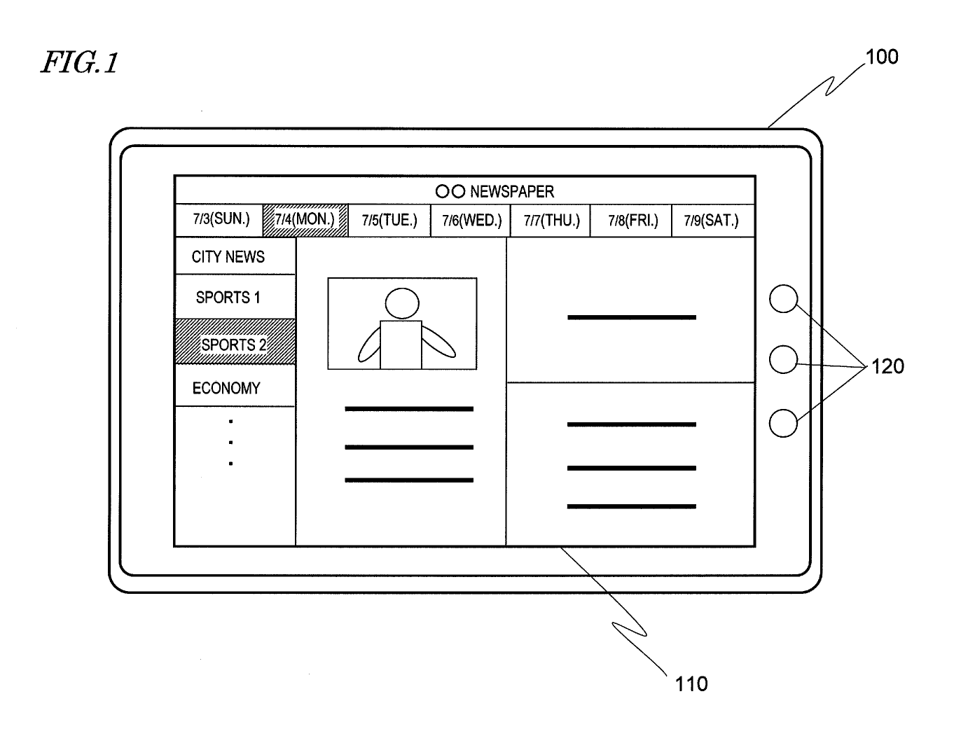

FIG. 1 is a diagram illustrating the exterior appearance of an information processing terminal 100 (hereinafter, sometimes referred to simply as “terminal”) according to this embodiment. The information processing terminal 100 of this embodiment is a terminal that has a function of displaying, on its display, data of newspaper articles distributed from a distribution server of a newspaper publishing company or the like.

The information processing terminal 100 includes a touch screen 110, which has a display for displaying contents and a touch sensor that detects an input from a user, and operation buttons 120, which make common operation of the information processing terminal 100 possible. The information processing terminal 100 may also include a power switch, an external IF, a camera, a speaker, a microphone, and others that are not particularly necessary for the understanding of the present invention and are therefore omitted from the description. The operation buttons 120 may be buttons that recognize an input by detecting the approach of a finger or the like with a touch sensor, or buttons that detect an input when actually pressed by the user.

FIG. 1 illustrates an example of a state in which newspaper article contents are displayed on the touch screen 110. The information processing terminal 100 may be a multi-purpose information processing terminal capable of, in addition to displaying electronic newspapers, viewing Web pages, viewing electronic books, sending and receiving e-mail, playing audio, taking photographs, and the like.

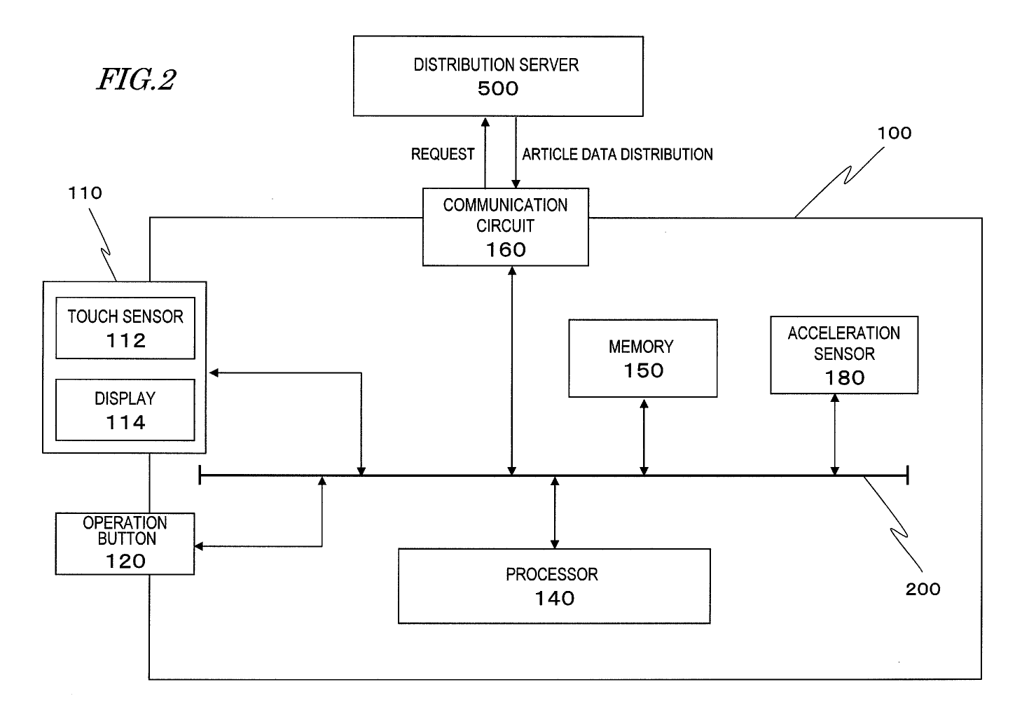

FIG. 2 is a block diagram illustrating a hardware configuration of the information processing terminal 100. FIG. 2 illustrates a distribution server 500 for distributing newspaper article data in addition to the information processing terminal 100. Other than the touch screen 110 and operation buttons 120 described above, the information processing terminal 100 includes a communication circuit 160 for holding wireless communication, a memory 150 for recording distributed article data and temporary data that is generated in the course of processing, an acceleration sensor 180 for detecting the direction of the information processing terminal 100, and a processor (control unit) 140 for controlling the operation of respective function units. The processor 140 is connected to the respective function units via a bus 200.

The touch screen 110 includes, as described above, the touch sensor which is denoted by 112 and detects an input from the user, and the display which is denoted by 114 and displays information. The touch screen 110 can be implemented by any known method as long as the method allows an input from the user and an output to the display.

The operation buttons 120 may be, as described above, buttons that detect an input with a touch sensor or buttons that detect an input when actually pressed by the user. The operation buttons 120 may include a button for calling up an initial screen (home screen) of the information processing terminal 100, a button for returning to the preceding screen display, a button for calling up a screen on which various settings of the terminal are made, and the like.

The processor 140 may be configured from, for example, a combination of an integrated circuit that includes a known central processing unit (CPU) and graphics processing unit (GPU) with various programs, or from dedicated hardware. The processor 140 controls what is displayed on the display 114 based on inputs from the operation buttons 120, the touch sensor 112, the communication circuit 160, the acceleration sensor 180, and others, and also controls communication to/from the distribution server 500.

The memory 150 is a known semiconductor memory such as a DRAM or an SRAM. The memory 150 stores input data from the operation buttons 120, the touch sensor 112, the communication circuit 160, the acceleration sensor 180, and others, and various types of temporary data that are generated in processing of the processor 140. The memory 150 also stores various programs executed by the processor 140.

The communication circuit 160 is a known communication circuit for transmitting an article data request signal to the distribution server 500, which is provided on a site remote from the terminal, upon instruction from the processor 140, and for receiving distributed article data. The communication circuit 160 performs wireless communication in conformity to, for example, the IEEE 802.11 standards, and can connect to the Internet via a telephone line, an optical fiber network, a cellular phone network, or the like.

The acceleration sensor 180 is a sensor that detects the tilt of the information processing terminal 100. The processor 140 performs control for rotating what is displayed on the display 114 depending on the tilt detected by the acceleration sensor 180. Instead of the acceleration sensor 180, other types of sensors such as a gyroscope may be used to detect the tilt of the information processing terminal 100.

Examples of screen configurations used to display newspaper articles on the information processing terminal 100 are described below.

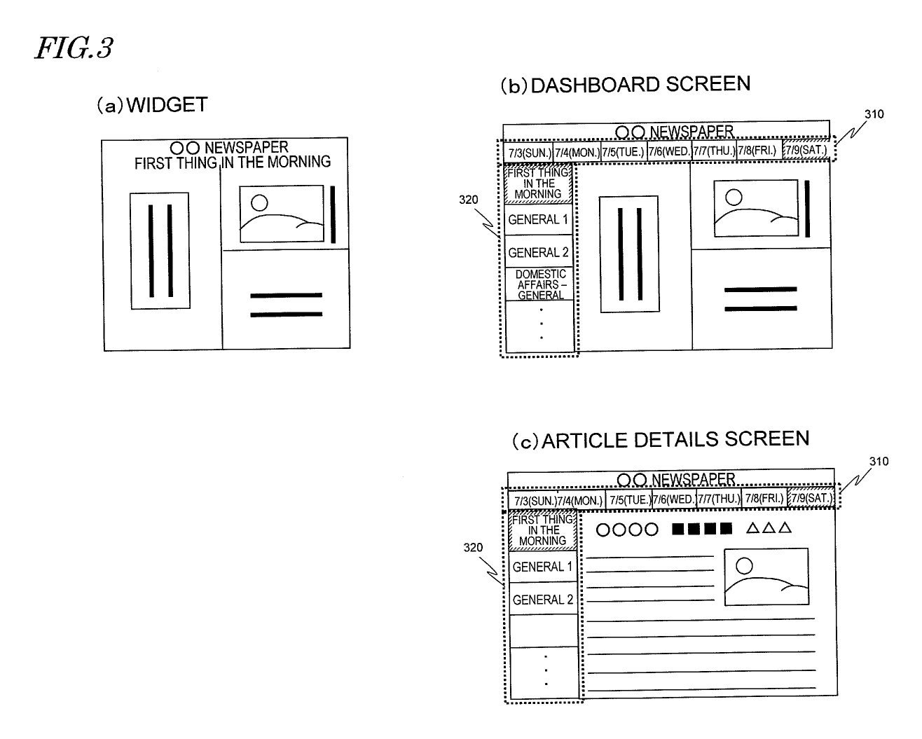

FIG. 3 are diagrams illustrating examples of screen configurations for displaying newspaper article contents on the information processing terminal 100. In this embodiment, screens prepared to display newspaper articles are roughly divided into a widget-based display screen and a dedicated application-based display screen.

FIG. 3(a) illustrates an example of the widget-based display screen. For example, the widget-based display screen may be displayed after the terminal is booted up based on settings customized in advance by the user. The widget-based display screen displays the headlines and photographs of main articles of the day by switching from, for example, page to page of a newspaper at regular time intervals. This allows the user to know a page-by-page digest of newspaper articles of the day without activating a dedicated application. Though not shown in FIG. 3(a), the widget-based screen may display advertisement and extra news information in addition to article information.

FIGS. 3(b) and 3(c) illustrate examples of the dedicated application-based display screen. When an application activating icon displayed on the initial screen of the information processing terminal 100 is selected (tapped), or when one of article compartments displayed by the widget described above is tapped, a dedicated application is activated and one of the screens illustrated as examples in FIGS. 3(b) and 3(c) is displayed.

FIG. 3(b) illustrates an example of a screen that is displayed when the application activating icon is selected. This screen is for displaying a digest (dashboard) of contents sorted by date information 310 and category information 320. This dashboard is prepared for each article, and takes the form of headlines or photographs, or a combination of headlines and photographs. The screen of FIG. 3(b) is hereinafter referred to as “category display screen” or “dashboard screen”. In this embodiment, information displayed by the widget of FIG. 3(a) is the same as information displayed in this dashboard screen. In FIG. 3(b), dashboards for three articles are displayed in one screen, but the number or articles displayed in one screen is not limited to three. In the case where displaying dashboards for all articles of one category in one screen is not possible, headlines of the rest of the articles may be placed, for example, on the right-hand side of the screen. The terminal may be designed so that selecting the headline of an article for which a dashboard is not displayed causes a transition to a details screen of the selected article.

The date information 310 is information for specifying the date of an article to be displayed. The date information 310 in the illustrated example is a week's worth of dates displayed side by side at the top of the screen. It is preferred to display the date information 310 in this manner, where a given number of days (e.g., seven days) counted back from the latest date among already obtained pieces of newspaper article data are displayed at the same time. FIG. 3(b) illustrates an example in which the information processing terminal 100 is used on Saturday, July 9. This screen configuration allows the user to specify a desired date from among a plurality of dates with ease. When the user specifies a date, the terminal displays articles of the specified date that belong to the same category as that of the currently displayed article or a similar category as described later. Older date information that precedes the currently displayed dates may be displayed with the user's action in which a finger or the like is slid horizontally over the area where the date information 310 is displayed. Alternatively, the terminal may be configured to display a button for displaying older date information so that date information older by, for example, a week is displayed each time the button is tapped. In FIG. 3(b), information of the given number of days is displayed with the latest date, “7/9 (Sat.)”, set up on the right edge of the top of the screen. Instead, information of the given number of days may be displayed with the latest date set up on the left edge of the top of the screen.

The category information 320 is information for specifying the category of an article to be displayed. The category information 320 in the illustrated example is categories displayed on top of one another on the left-hand side of the screen. The categories correspond to pages of a newspaper on a one-on-one basis. For example, the front page of a newspaper corresponds to a “first thing in the morning” category, and the first page of the sports section corresponds to a “sports 1” category. The terminal in this embodiment is set to display dashboards of the “first thing in the morning” category immediately after the application is activated. The category information 320 allows the user to specify a desired category from among a plurality of categories with ease. When the user specifies a category, the terminal displays articles belonging to the specified category that have the same date as that of the currently displayed article. In the case where there are too many categories to contain the entire category information 320 in one screen, the screen may be scrolled vertically to display out-of-view categories.

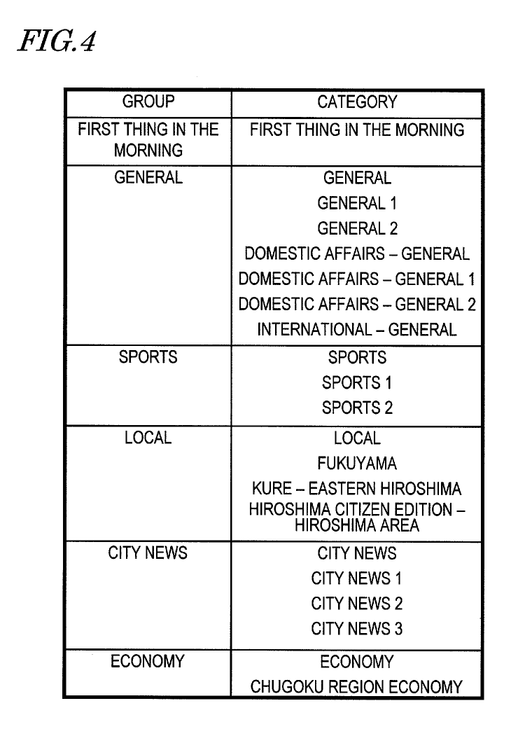

An example of information displayed as the category information 320 is described. FIG. 4 is a diagram illustrating an example of information that is displayed as the category information 320. Words written in a category field of a table illustrated in FIG. 4, such as “first thing in the morning” and “general”, are displayed as the category information 320 on the screen. In the example of FIG. 4, categories are classified into a plurality of groups so that related categories belong to the same group. The processor 140 keeps information as the one illustrated in FIG. 4 in the memory to display the category information 320 on the display 114 based on this information. The processor 140 can also determine the similarity among a plurality of categories based on the classification of FIG. 4 as described later.

FIG. 3(c) illustrates an example of a screen that is displayed when one of articles displayed by the widget is selected or one of articles displayed in the dashboard screen is selected. This screen displays details of the selected article, and is called hereinafter as “article details screen”. The article details screen, too, displays the date information 310 and the category information 320 so that an article of a date and category selected by the user is displayed. In the case where an article is not contained in one screen, the article details screen can be scrolled with the user's action in which a finger or the like is slid over the screen up and down. In the case where a displayed category has a plurality of articles, the article details screen can display preceding and following articles that belong to the same date and the same category with the user's action in which a finger or the like is slid over the screen to the left and the right. In the article details screen, an enlarged photograph may be displayed by tapping a part of a photograph that is put alongside the article.

Information displayed in the dashboard screen and the article details screen can be enlarged or reduced by the user's action in which the user stretches or shrinks a display area with two fingers (pinching on the touch screen).

The layout of the date information 310 and the category information 320 may differ from the one in the examples of FIGS. 3(a) to 3(c). For example, dates of the date information 310 may be displayed on top of one another whereas categories of the category information 320 may be displayed side by side. Alternatively, the date information 310 and the category information 320 may be arranged horizontally or vertically parallel to each other.

The examples of FIGS. 3(a) to 3(c) show screen images of the information processing terminal 100 that is in a horizontal display mode. The layouts of these screens may be changed when the information processing terminal 100 is tilted by, for example, 90 degrees and set in a vertical display mode. For instance, the date information 310 and the category information 320 in the vertical display mode may be arranged on top of each other at the top of the screen with dates placed side by side and categories placed side by side, or may be arranged next to each other on the left-hand side of the screen with dates placed on top of one another and categories placed on top of one another.

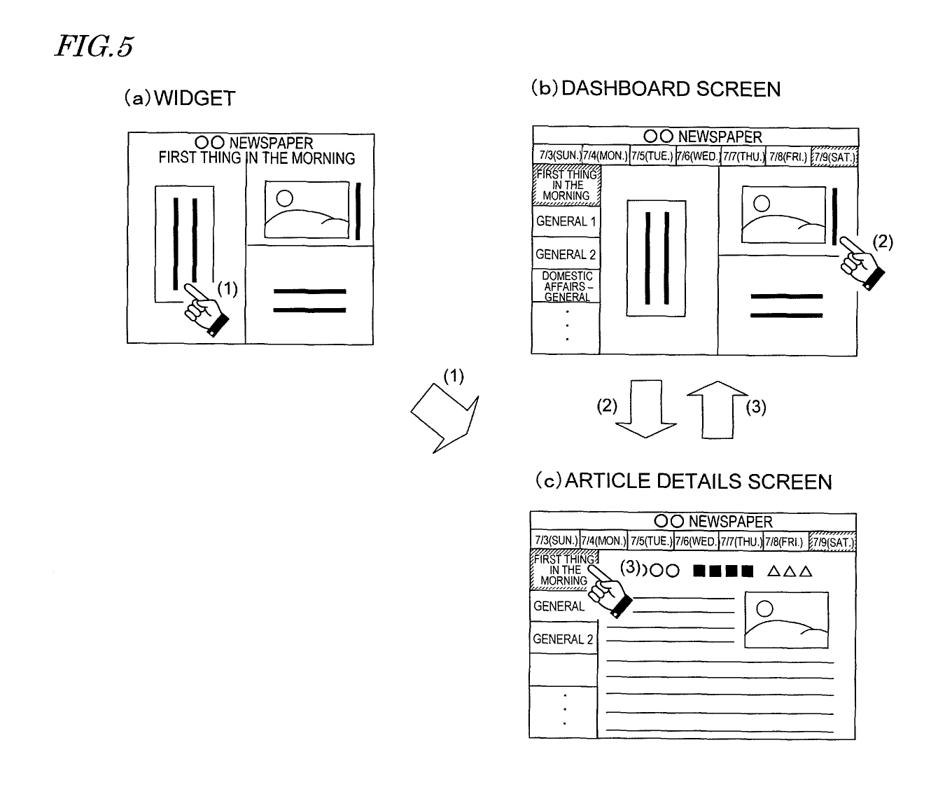

FIGS. 5(a) to 5(c) are diagrams illustrating an example of a method of transition between these screens. Tapping inside the compartment of a specific article that is displayed by the widget of FIG. 5(a) causes the terminal to display the article details screen of FIG. 5(c) ((1) in FIGS. 5(a) to 5(c)). Similarly, tapping the compartment of a specific article in the dashboard screen of FIG. 5(b) causes a transition to the article details screen of this article ((2) in FIGS. 5(a) to 5(c)). When a specific category is selected in the article details screen, on the other hand, the terminal shifts to the dashboard screen of this category ((3) in FIGS. 5(a) to 5(c)). The terminal in this embodiment shifts to the dashboard screen of a category selected in the article details screen, irrespective of whether the selected category is the same as or differs from the category of the currently displayed article.

The operation of displaying a details screen of a specific article by tapping inside the compartment of the article in the widget-based screen and the dashboard screen is implemented by, for example, the following mechanism. The information processing terminal 100 keeps “article area information” indicating which area of the touch screen 110 is associated with which article in, for example, the memory 150. The processor 140 recognizes which point on the touch screen 110 has been tapped by the user, identifies an article that is associated with the tapped point by referring to the article area information, and displays the details screen of the identified article.

An operation that the terminal performs when the user changes the date is described next.

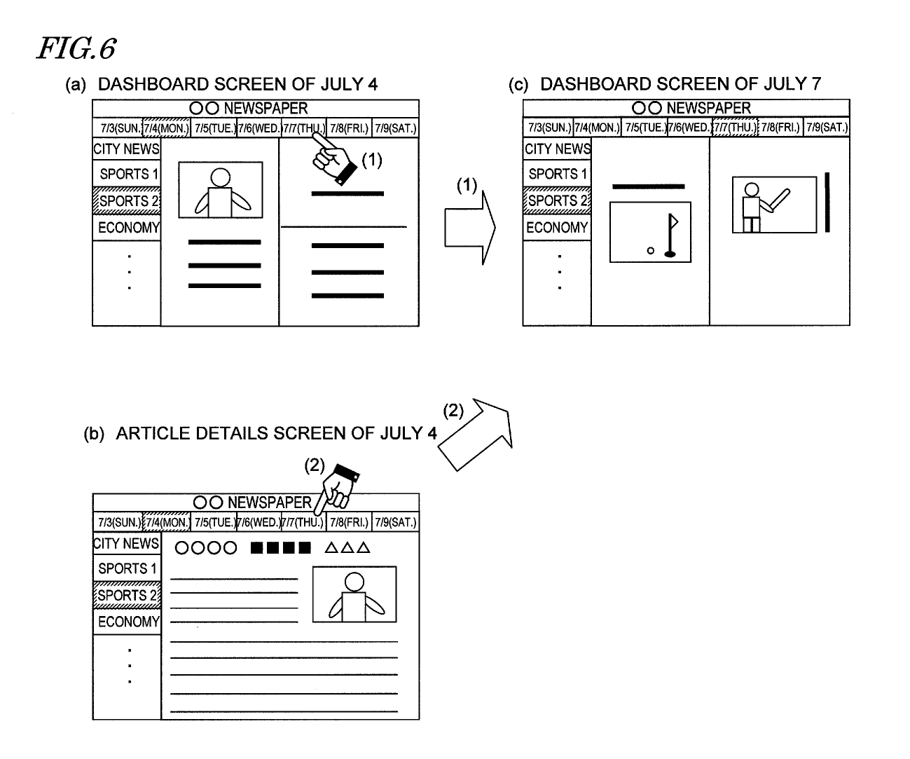

FIGS. 6(a) to 6(b) are diagrams illustrating an example of screen transition that occurs when the user changes the date while the dashboard screen or the article details screen is displayed. First, as illustrated in FIG. 6(a), the dashboard screen of a “sports 2” category for Monday, July 4, is displayed. In this state, the user taps a part of the date information where “7/7 (Thu.)” is displayed, causing a transition to the dashboard screen of FIG. 6(c) which is of the “sports 2” category for Thursday, July 7 ((1) in FIGS. 6(a) to 6(c)). The terminal shifts to the screen of FIG. 6(c) also when the user taps a part of the date information where “7/7 (Thu.)” is displayed while viewing the article details screen of the “sports 2” category for Monday, July 4, as illustrated in FIG. 6(b) ((2) in FIGS. 6(a) to 6(c)).

Thus, when a date different from the date of the currently displayed article is specified, the dashboard screen of the same category for the specified date is displayed. There may be cases where articles of the same category do not have the specified date. For instance, the currently displayed “sports 2” category may include no articles of the specified date. In such cases, when a similar category includes articles of the specified date, the information processing terminal 100 displays the dashboard screen of this category. For example, when the “sports 2” category includes no articles of the specified date, the dashboard screen of “sports” is displayed instead. Similar categories are, for example, “sports” and “sports 2”, and “general 1” and “general 2”. When there is no category similar to the category of the currently displayed article, the initial screen which is set in advance (for example, the front page) is displayed.

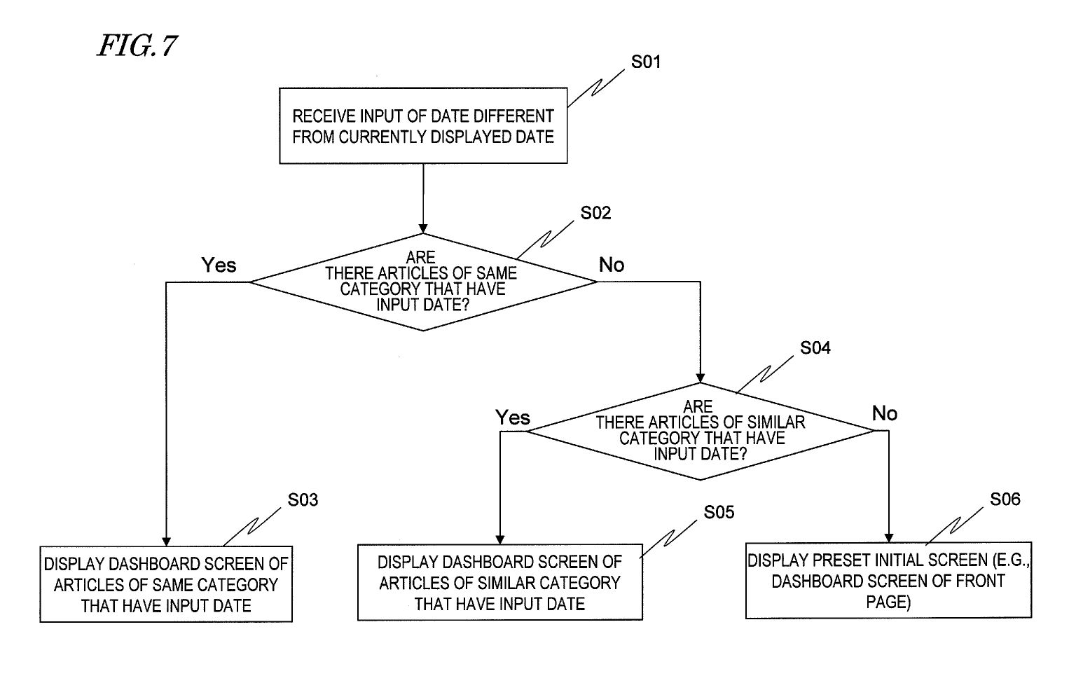

FIG. 7 is a flow chart illustrating the flow of processing that is executed by the information processing terminal 100 in order to implement the date changing operation described above. First, an input of a date different from the date of the currently displayed article is received via the touch sensor 112 (Step S01), and the processor 140 determines whether or not there are articles of the same category as that of the currently displayed article (Step S02). When there are articles of the same category that have the specified date, the processor 140 displays the dashboard screen of this category on the display 114 (Step S03). When there are no articles of the same category that have the specified date, the processor 140 determines whether or not there are articles of a similar category that have the specified date (S04). When there are articles of a similar category that have the specified date, the processor 140 displays the dashboard screen of the similar category on the display 114 (Step S05). When there are not even articles of a similar category that have the specified date, the processor 140 displays the initial screen set in advance (for example, the dashboard screen of the front page) on the display 114.

How the presence or absence of articles of a similar category is determined is described next. For example, the information processing terminal 100 can determine as a similar category a category that is found through a prefix search to have a name partially overlapping with the current category name. Alternatively, the terminal may determine similarity based on a table that defines preset similar categories as the one illustrated in FIG. 4. The information processing terminal 100 holds the information of FIG. 4 in the memory 150 in the form of a table, and the processor 140 refers to this table to determine similarity. For example, in the case where the currently displayed article is an article of an “international—general” category and there are no articles of the “international—general” category that have the specified date, articles of a “general” category which belongs to the same “general” group and which is at the top of the group are displayed if there are any on the specified date. The information processing terminal 100 may skip the determination of similarity to display the preset initial screen immediately after it is found that there are no articles of the same category.

As described, when a date different from the date of the currently displayed contents is selected, the information processing terminal 100 of this embodiment displays contents of the same category as that of the currently referred contents or a similar category. According to this embodiment, when the date is changed, contents highly related to those that have just been viewed can be viewed successively without needing to shift to the initial screen, and users' convenience is thus improved compared to conventional information processing terminals.

Other functions of the information processing terminal 100 of this embodiment are described next. The information processing terminal 100 may include, in addition to the date changing operation described above, the following functions.

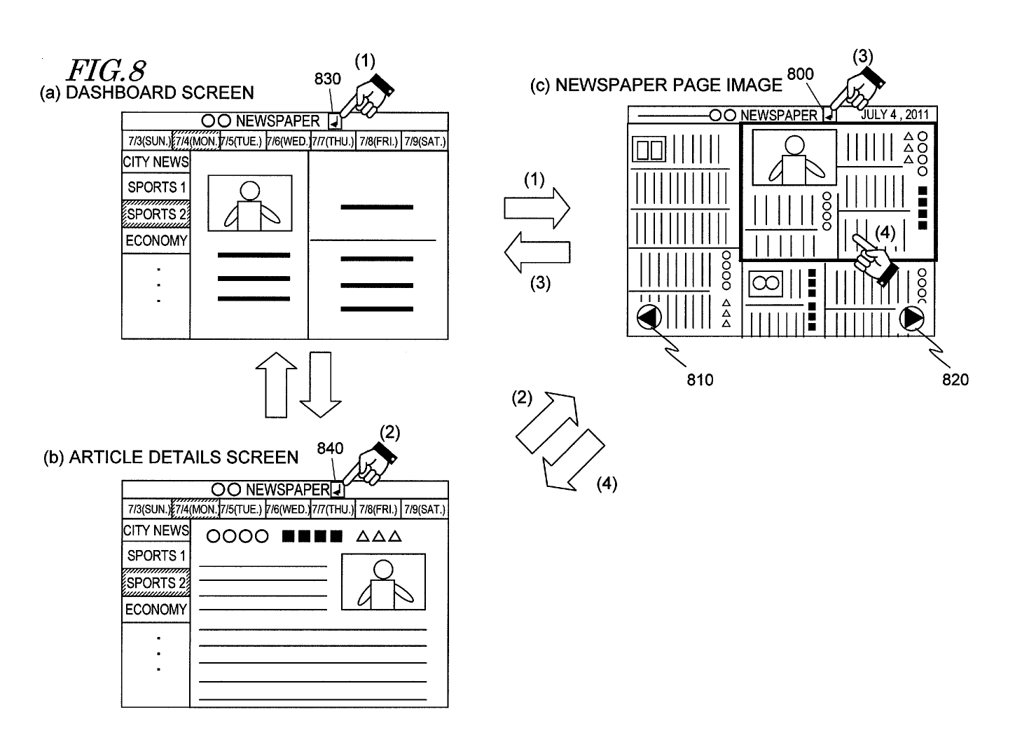

FIGS. 8(a) to 8(c) are diagrams illustrating an example of an operation of switching display from the dashboard screen or the article details screen to a newspaper page image. The dashboard screen of FIG. 8(a) and the article details screen of FIG. 8(b) respectively have a button 830 and a button 840 which are displayed at the top of the screens. Tapping the button 830 or 840 causes the terminal to display a newspaper page image corresponding to an article that has just been displayed as illustrated in FIG. 8(c) ((1), (2) in FIGS. 8(a) to 8(c)). In this embodiment, where categories and newspaper pages correspond to each other on a one-to-one basis, the newspaper page image of a page corresponding to a category that has just been displayed is displayed.

A converse transition from a newspaper page image to the dashboard screen or the article details screen is also possible. For example, the newspaper page image screen of FIG. 8(c) has a button 800 for returning to the dashboard screen, and tapping this button cause a transition to the dashboard screen that corresponds to the displayed page ((3) in FIGS. 8(a) to 8(c)). Instead of displaying the button 800, the terminal may assign an equivalent function to one of the operation buttons 120 of FIG. 1. The terminal may also be configured so that tapping an area in a newspaper page image where an article is put causes a transition to the article details screen of the article ((4) in FIGS. 8(a) to 8(c)). Alternatively, the terminal may be configured so as to execute the operation of (1) in FIGS. 8(a) to 8(c) and the operation of (2) in FIGS. 8(a) to 8(c) when “oo newspaper” displayed in the dashboard screen and the article details screen is tapped. In this example, too, the transition between the dashboard screen and the article details screen is executed by the screen switching method described above with reference to FIGS. 5(a) to 5(c).

A newspaper page image is exactly the same as a page of a newspaper delivered to home or sold in stores. The article details screen may not hold all pieces of information of a newspaper due to limitations to information volume and space. In such cases, too, the user can read all pieces of information by referring to a newspaper page image. The user can freely scroll and enlarge/reduce the newspaper page image screen as is the case for the article details screen and other screens. Tapping page switching buttons 810 and 820 of FIG. 8(c) causes the screen to shift page by page.

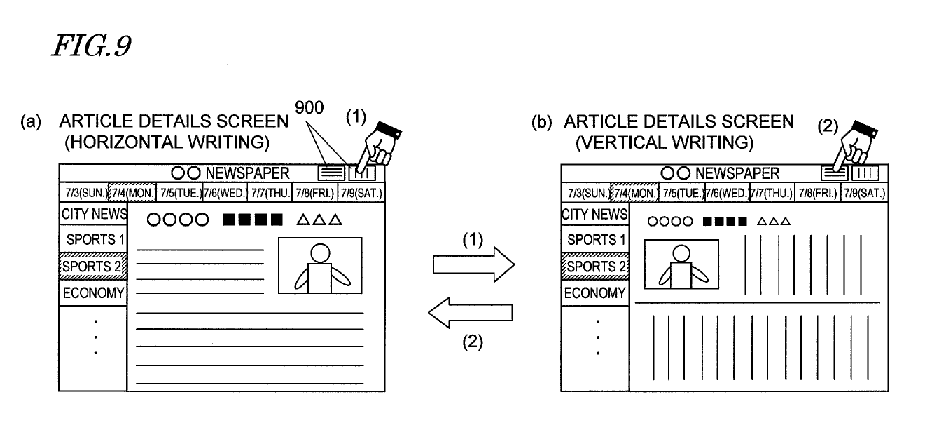

FIGS. 9(a) and 9(b) are diagrams illustrating an operation of switching between a horizontal writing display mode and a vertical writing display mode. The information processing terminal 100 may have a function of switching the display mode of the article details screen between horizontal writing display and vertical writing display. A newspaper in Japanese is usually written vertically, and a need for vertically written Japanese articles to read on the information processing terminal 100 is expected. Display switching buttons 900 for switching between horizontal writing and vertical writing may therefore be provided in the article details screen as illustrated in FIG. 9(a). Tapping the display switching buttons 900 allows conversion from horizontal writing to vertical writing ((1) in FIGS. 9(a) to 9(c)) and conversion from vertical writing to horizontal writing ((2) in FIGS. 9(a) to 9(c)).

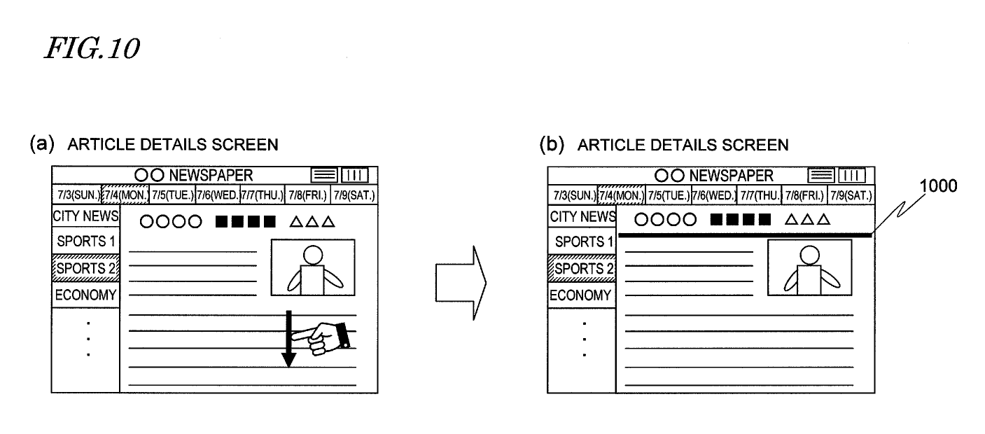

FIGS. 10(a) and 10(b) are diagrams illustrating an example of an operation of displaying an alert about the fact that the article details screen cannot be scrolled further. The article details screen cannot be scrolled further after the end of an article is reached. At that point, the information processing terminal 100 displays a red line (alert display) 1000 in order to inform the user of the fact that the end of the article has been reached. This function calls the user's attention to an unintended scrolling action due to a slip of a finger that occurs when, for example, the user is trying to display an enlarged view of a photograph in the article by tapping the photograph. The alert display which is a red line in this embodiment can be any display form as long as the user's attention can be drawn.

An example of data distribution to the information processing terminal 100 and distributed data is described next.

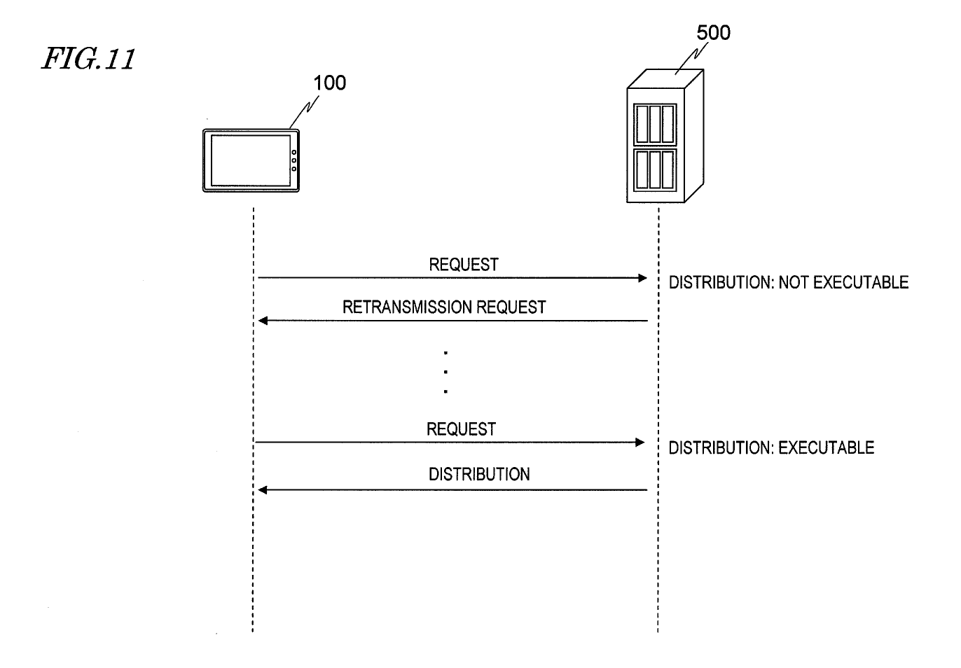

FIG. 11 is a diagram illustrating an example of information communication between the information processing terminal 100 and the distribution server 500 of a newspaper publishing company which is provided on a site remote from the terminal. The information processing terminal 100 in this embodiment obtains newspaper article data every morning from the distribution server 500 placed on a site remote from the terminal. In the illustrated example, the information processing terminal 100 requests distribution from the distribution server 500 every morning at a fixed time (for example, 5 a.m.). The distribution server 500 distributes article data of the day in response to the request. However, depending on the processing performance of the distribution server 500, a limit to transmission traffic volume, and other factors, the distribution server 500 may be unable to distribute data when many requests arrive at the same time or the like. In such cases, the distribution server 500 notifies the information processing terminal 100 to request again after waiting for a given period of time (a retransmission request). Receiving the retransmission request, the information processing terminal 100 waits for a given period of time (five minutes, for example) and then requests distribution again. The distribution server 500 receives the request and, after determining that distribution is possible, distributes article data to the information processing terminal 100.

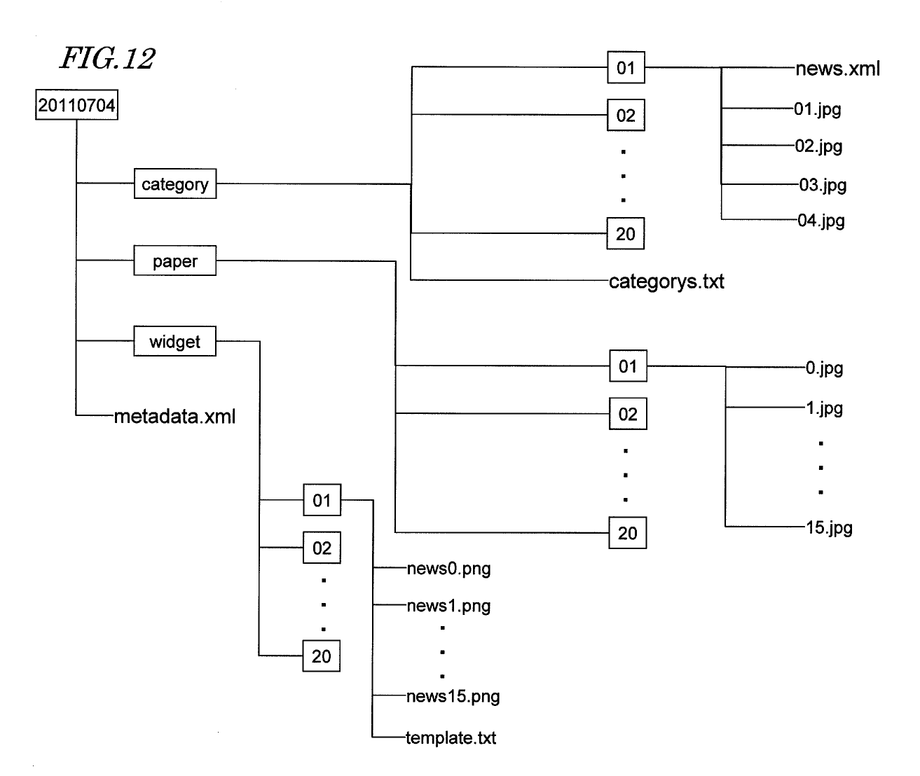

FIG. 12 is a diagram illustrating an example of the data structure of article data which is distributed to the information processing terminal 100. The information processing terminal 100 receives data that has the illustrated data structure from the distribution server 500 every morning. In FIG. 12, letters enclosed in a rectangle represent a directory (or a folder), and letters that are not enclosed in a rectangle represent a file. In the case where the distribution date is Jul. 4, 2011, the article data is stored under a directory “20110704” to be distributed.

The “20110704” directory includes a “category” directory, a “paper” directory, a “widget” directory, and “metadata.xml” file. The “category” directory stores data of contents displayed in the dashboard screen and the article details screen. The “paper” directory stores image data displayed in the newspaper page image screen. The “widget” directory stores image data displayed in the widget-based screen. The “category” directory, the “paper” directory, and the “widget” directory each include directories “01” to “20”, which correspond to respective pages (categories) of the newspaper. Specifically, the “01” directory stores data relevant to the front page and the “20” directory stores data relevant to the 20th page (the last page). The file “metadata.xml” is an Extensible Markup Language (XML) file that describes metadata such as date.

The “category” directory includes “categorys.txt” which describes a list of category names. The information processing terminal 100 refers to this data to display category information in the dashboard screen and the article details screen. The directories “01” to “20” that are included in the “category” directory each include a “news.xml” file and a plurality of Joint Photographic Experts Group (JPEG) files. The “news.xml” file is an XML file that describes text data of every article belonging to the category in question, paths to image data (the JPEG files described above), and article layout information. The processor 140 refers to this XML file to display respective articles on the display 114. FIG. 12 omits files under directories other than the “01” directory.

For each page of a newspaper, data of a newspaper page image is broken into 16 pieces, which are stored in the “paper” directory. The directories “01” to “20” each store 16 JPEG files. These JPEG files are obtained by breaking a newspaper paper image into 16 images, which together constitute one page of newspaper image. The processor 140 receives from the user a request to display a newspaper page image, and then uses these JPEG files to display the newspaper page image screen. FIG. 12 omits files under directories other than the “01” directory.

The “widget” directory stores data for defining the compartments of images displayed in the widget-based screen and the dashboard screen. The directories “01” to “20” each store 16 Portable Network Graphics (PNG) files and a “template.text” file. The “template.text” file describes compartment information for defining the compartments of respective articles in the widget-based screen and the dashboard screen. The compartment information is used as the “article area information” described above. Files “news0.png” to “news15.png” are pieces of data obtained by dividing an image that is displayed in the widget-based screen and the dashboard screen into 16 images by category. The compartment information indicates which part of the screen divided equally into 16 parts and represented by these pieces of data is associated with which article. The “article area information” is not limited to this example, and may be information indicating which coordinates on the screen are associated with which article. For instance, in the case where a point on the screen is expressed by rectangle coordinates, the “widget” directory may record a file defining which coordinates are associated with which article, instead of the above-mentioned compartment information. In addition to the data described above, the “widget” directory may store advertisement image data and the like.

The distributed data described above allows the information processing terminal 100 to display latest article data. The information processing terminal 100 receives every morning distributed data whose exemplary data structure is illustrated in FIG. 12 and stores the data in the memory 150. The processor 140 reads data received that day out of the memory 150 to construct the widget-based screen, the article dashboard screen, and the article details screen, and displays the screens on the display 114. The data structure of FIG. 12 is merely an example, and the distributed data can have any data structure as long as the operations in this embodiment can be implemented.

As described above, the information processing terminal 100 of this embodiment displays contents based on newspaper article data which is distributed from the distribution server 500 of a newspaper publishing company. However, the present invention is not limited to this mode. For example, the displayed contents are not limited to newspaper articles, but may be articles of a magazine or the like as long as the contents are data sorted by the date information and the category information. Article data may be recorded in the information processing terminal 100 via a recording medium instead of a telecommunication line.

Programs that define the above-mentioned processing procedures which are executed by the processor 140 in this embodiment can be distributed independently of the information processing terminal 100. These programs can be recorded in the information processing terminal 100 via, for example, a telecommunication line or via a recording medium such as a CD-ROM, a DVD-ROM, a magnetic tape, or a memory card.

### INDUSTRIAL APPLICABILITY

The present invention, where changing the date causes the terminal to display contents that are highly related to those that have just been displayed, is applicable to devices for displaying, for example, electronic newspapers.

### REFERENCE SIGNS LIST

100 information processing terminal
110 touch screen
112 touch sensor
114 display
120 operation button
140 processor
150 memory
160 communication circuit
180 acceleration sensor
200 bus
310 date information
320 category information
500 distribution server
800 button for returning to dashboard screen
810, 820 page switching button
830, 840 button for displaying newspaper page image
900 display switching button

1. An information processing terminal for displaying contents that are sorted by date information and category information, the information processing terminal comprising:
a display;
a touch sensor configured to detect an input from a user on the display; and
a control unit configured to display, on the display, the date information including a plurality of dates, the category information including a plurality of categories, and contents belonging to a date and a category that are selected by the user from among the plurality of dates of the date information and the plurality of categories of the category information, and the control unit configured to display, on the display, when a date different from a date of currently displayed contents is selected, contents of the selected date that belong to the same category as a category of the currently displayed contents or a category similar to the category of the currently displayed contents.

2. The information processing terminal according to claim 1, wherein, when the date different from the date of currently displayed contents is selected and there are no contents of the selected date that belong to the same category as the category of the currently displayed contents or the category similar to the category of the currently displayed contents, the control unit displays, on the display, an initial screen, which is set in advance, for the selected date.

3. The information processing terminal according to claim 1, wherein the display displays, as the date information, days within a preset period of time at the same time.

4. The information processing terminal according to claim 1, wherein the contents are newspaper articles.

5. The information processing terminal according to claim 4, wherein, when the date different from the date of currently displayed contents is selected and there are no contents of the selected date that belong to the same category as the category of the currently displayed contents or the category similar to the category of the currently displayed contents, the control unit displays, on the display, information about an article of a front page of a newspaper on the selected date.

6. An information processing terminal for displaying contents that are sorted by date information and category information, the information processing terminal comprising:
a display;
a touch sensor configured to detect an input from a user on the display;
a memory;
a processor; and
a program stored in the memory and configured to be executed by the processor, the program including the steps of:
displaying, on the display, the date information including a plurality of dates, the category information including a plurality of categories, and contents belonging to a date and a category that are selected by the user from among the plurality of dates of the date information and the plurality of categories of the category information; and
when a date different from a date of currently displayed contents is selected, displaying, on the display, contents of the selected date that belong to the same category as a category of the currently displayed contents or a category similar to the category of the currently displayed contents.

7. A display control method for use in an information processing terminal for displaying contents that are sorted by date information and category information, the display control method comprising the steps of:
displaying, on a display of the information processing terminal, the date information including a plurality of dates, the category information including a plurality of categories, and contents belonging to a date and a category that are selected by a user from among the plurality of dates of the date information and the plurality of categories of the category information; and
when a date different from a date of currently displayed contents is selected, displaying, on the display, contents of the selected date that belong to the same category as a category of the currently displayed contents or a category similar to the category of the currently displayed contents.

8. A non-transitory computer readable storage medium storing a program to be executed by a computer mounted in an information processing terminal for displaying contents that are sorted by date information and category information, the program causing the computer to execute the steps of:
displaying, on a display of the information processing terminal, the date information including a plurality of dates, the category information including a plurality of categories, and contents belonging to a date and a category that are selected by a user from among the plurality of dates of the date information and the plurality of categories of the category information; and
when a date different from a date of currently displayed contents is selected, displaying, on the display, contents of the selected date that belong to the same category as a category of the currently displayed contents or a category similar to the category of the currently displayed contents.
